(19) United States
(12) Patent Application Publication
(10) Pub. No.: US 2010/0282235 A1
(43) Pub. Date: Nov. 11, 2010

(54) BARBECUE GRILL STRUCTURE

(76) Inventor: Tung-Lin Lu, Jhonghe City (TW)

Correspondence Address: Muncy, Geissler, Olds & Lowe, PLLC, 4000 Legato Road, Suite 310, FAIRFAX, VA, 22033, US

(21) Appl. No.: 12/437,814

(22) Filed: May 8, 2009

(51) Int. Cl. A47J 37/00

(52) U.S. Cl. 126/25 R

(57) ABSTRACT

The present invention relates to a barbecue grill structure, which includes a first casing, a second casing and a holding grill, wherein a first side opening is defined in one side of a first holding space, and a top end is defined with a first top opening that intercommunicates with the first side opening. A second side opening is defined in the second casing corresponding to the first side opening, and a top end is defined with a second top opening that intercommunicates with the second side opening. The holding grill is dismountably mounted between the first side opening and the second side opening. Accordingly, the user can place charcoal within the first casing and the second casing, and place foodstuffs he wants to barbecue on the holding grill, and thereby achieve the practical advancement of simultaneous barbecuing of both sides of foodstuffs.

### BACKGROUND OF THE INVENTION

(a) Field of the Invention

The present invention provides a barbecue grill, and more particularly provides a barbecue grill structure that eliminates the need for repeated turning over of foodstuffs when barbecuing, while enabling simultaneous barbecuing of both sides of foodstuffs.

(b) Description of the Prior Art

In order to achieve promoting the pleasure of barbecuing, companies have developed all kinds of barbecue grill structures to meet user needs, for example, barbecue grills with optimized internal space to benefit air flow and further increase charcoal combustion efficiency; assembly-type barbecue grills which achieve easy disassembly, convenient portable barbecue grills, even barbecue grills which increase the heating area of the foodstuffs required to be barbecued.

Barbecue grills of the prior art are usually fabricated from a casing, a rack and a barbecue mesh. Interior of the casing is provided with a holding space for disposing charcoal, and the top of the casing is provided with an opening. The rack is installed underneath the casing, thereby enabling the casing to be effectively raised above the ground. The barbecue mesh is disposed at the position of the opening to enable foodstuffs to be placed thereon for barbecuing thereof.

Hence, according to the structure described above, the user needs only to dispose preheated charcoal in the holding space and place the foodstuffs requiring barbecuing on the barbecue mesh in order to enable the quantity of heat produced by the charcoal to barbecue the foodstuffs.

However, the following problems and shortcomings are still in need of improvement when using the aforementioned barbecue grills of the prior art:

When the user is barbecuing foodstuffs, because the quantity of heat produced by the charcoal is dispersed from the opening, thus, the foodstuffs placed on the barbecue mesh constantly receive heat while barbecuing. However, because dispersal of the quantity of heat is only directed towards one side of the foodstuffs while barbecuing, thus, if the other side requires barbecuing, then the foodstuffs must be repeatedly manually turned over, which commonly results in the user being flustered, even to the extent that when the user is not paying attention, there is the frequent possibility of burning the foodstuffs, and if burnt foodstuffs are mistakenly eaten, there is even the possibility of causing cancer.

Hence, it is the strong desire of the inventor and manufacturers engaged in related art and purpose of the present invention to research, improve and resolve the problems and shortcomings of the aforementioned prior art.

### SUMMARY OF THE INVENTION

The primary objective of the present invention lies in providing a barbecue grill that enables simultaneous barbecuing of both sides of foodstuffs.

In order to achieve the aforementioned objective, a barbecue grill of the present invention comprises a first casing, a second casing and a holding grill, wherein the interior of the first casing is defined with a first holding space, a first side opening is defined in one side of the first holding space, a top end is defined with a first top opening that intercommunicates with the first side opening, a first side mesh is located at the position of the first side opening, and a first top mesh is mounted on the position of the first top opening. The interior of the second casing is defined with a second holding space, a second side opening is defined in one side of the second holding space corresponding to the first side opening, a second side mesh is located at the position of the second side opening, and a second top mesh is mounted on the position of a second top opening. The holding grill is dismountably mounted between the first side opening and the second side opening, and two side meshes respectively upwardly extend from two sides of the holding grill.

Hence, according to the aforementioned structure, the user can place charcoal in the first holding space of the first casing and the second holding space of the second casing to preheat the charcoal, after which foodstuffs the user wants to barbecue (such as: slices of bread) can be placed on the holding grill, and other foodstuffs the user wants to barbecue (such as: sliced meat) can be placed on the first top mesh first of the first casing and the second top mesh of the second casing. Because the quantity of heat produced by the charcoal disperses towards the first top opening and the first side opening of the first casing, as well as dispersing towards the second top opening and the second side opening of the second casing, thus, the sliced meat on the first top mesh of the first casing, as well as the sliced meat on the second top mesh of the second casing are effectively barbecued, while at the same time achieving effectiveness to simultaneously barbecue both sides of the slices of bread on the holding grill using heat from the first side opening and the second side opening. Accordingly, the present invention achieves the practical advancement of simultaneous barbecuing of both sides of foodstuffs, time saving and simplifying the effort required to barbecue foodstuffs.

Moreover, because the holding grill of the present invention is dismountably disposed between the first side opening and the second side opening, thus, after barbecuing of food is completed, the food can be conveniently taken from the holding grill, and also facilitates examining the cooked state of the food during barbecuing thereof to determine whether or not to continue heating the food.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational view of a preferred embodiment of the present invention.

FIG. 2 is an exploded elevational view of the preferred embodiment of the present invention.

FIG. 3 is an implementation schematic view 1 of the preferred embodiment according to the present invention.

FIG. 4 is an implementation schematic view 2 of the preferred embodiment according to the present invention.

FIG. 5 is an implementation schematic view 3 of the preferred embodiment according to the present invention.

FIG. 6 is an implementation schematic view 4 of the preferred embodiment according to the present invention.

FIG. 7 is an implementation schematic view 5 of the preferred embodiment according to the present invention.

FIG. 8 is an implementation schematic view 6 of the preferred embodiment according to the present invention.

FIG. 9 is an implementation schematic view 7 of the preferred embodiment according to the present invention.

FIG. 10 is an implementation schematic view 1 of another preferred embodiment according to the present invention.

FIG. 11 is an implementation schematic view 2 of the other preferred embodiment according to the present invention.

### DETAILED DESCRIPTION OF THE PREFERRED EMBODIMENTS

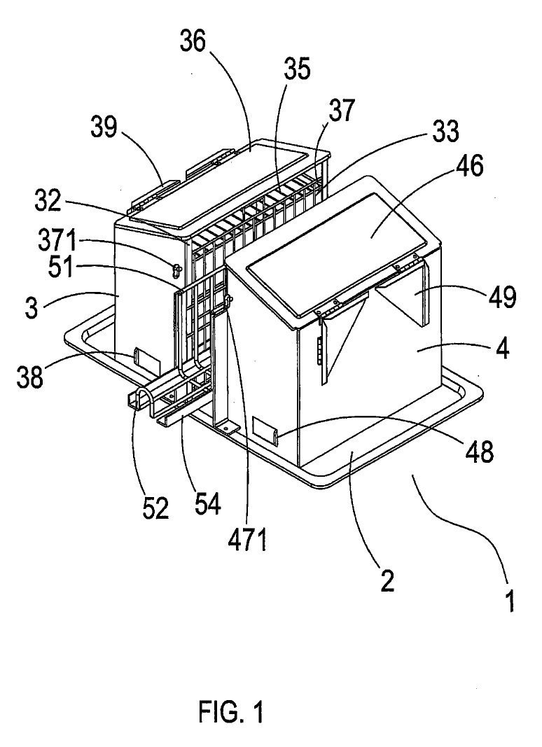

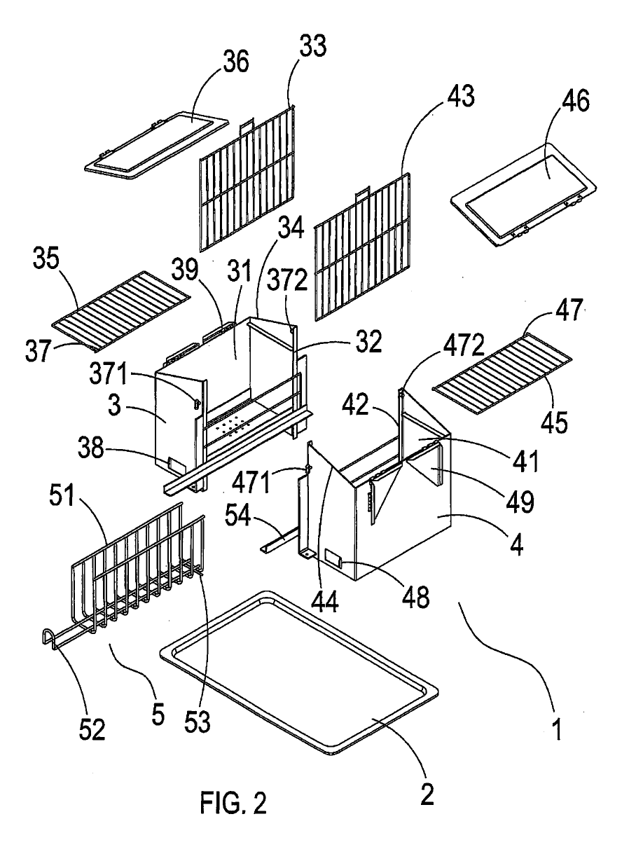

Referring to FIG. 1 and FIG. 2, which show an elevational view and an exploded elevational view respectively of a preferred embodiment of the present invention, and it can be clearly seen from the drawings that a barbecue grill 1 of the present invention comprises:

A first casing 3, and the interior of the first casing 3 is defined with a first holding space 31. A first side opening 32 is defined in one side of the first holding space 31, and a top end is defined with a first top opening 34 that intercommunicates with the first side opening 32. The first top opening 34 is covered with a first cover plate 36, and a first top mesh 35 is mounted on the position of the first top opening 34. First pin connected portions 37 extend from the first top mesh 35, and the first pin connected portions 37 enable the first top mesh 35 to be movably connected to the first casing 3. The first pin connected portions 37 are further magnetically connected to first magnetic members 371, and a first side mesh 33 is further mounted on the position of the first side opening 32.

A second casing 4, and the interior of the second casing 4 is defined with a second holding space 41. A second side opening 42 is defined in one side of the second holding space 41 corresponding to the first side opening 32, and a top end is defined with a second top opening 44 that intercommunicates with the second side opening 42. The second top opening 44 is covered with a second cover plate 46, and a second top mesh 45 is mounted on the position of the second top opening 44. Second pin connected portions 47 extend from the second top mesh 45, and the second pin connected portions 47 are further magnetically connected to second magnetic members 471. The second pin connected portions 47 enable the second top mesh 45 to be movably connected to the second casing 4. Moreover, a second side mesh 43 is further mounted on the position of the second side opening 42.

A holding grill 5, and the holding grill 5 is dismountably mounted between the first side opening 32 and the second side opening 42. Two side meshes 51 respectively upwardly extend from two sides of the holding grill 5, and a handle 52 extends from one end of the holding grill 5. The holding grill 5 is disposed on supports 54, and a fastening member 53 which enables fastening to the supports 54 is located at one end of the holding grill 5.

Furthermore, the barbecue grill 1 of the present invention is placed on a bottom tray 2, and air regulators 38, 48 penetrate the first casing 3 and the second casing 4 respectively to enable circulation of air. First support stands 39 which enable supporting the first cover plate 36 are formed on the first casing 3, and second support stands 49 which enable supporting the second cover plate 46 are formed on the second casing 4. Magnets 372, 472 able to magnetically attract the first top mesh 35 and the second top mesh 45 are formed on the inner walls of the first casing 3 and the second casing 4 respectively.

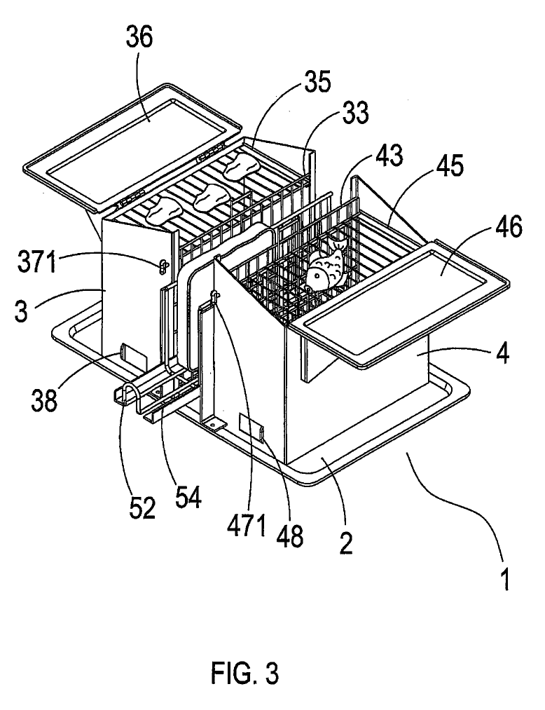

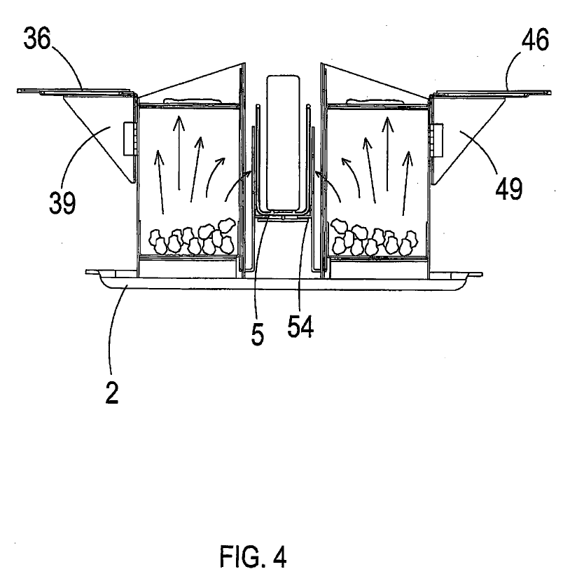

According to the aforementioned structure and constructional design, circumstances during operational use of the present invention are described hereinafter. Referring together to FIG. 2, FIG. 3 and FIG. 4, which show the exploded elevational view and implementation schematic views 1, 2 respectively of the preferred embodiment according to the present invention, and it can be clearly seen from the drawings that because the first casing 3 and the second casing 4 of the barbecue grill 1 of the present invention are provided with the first holding space 31 and the second holding space 41 respectively, thus, the user is able to fill the first holding space 31 and the second holding space 41 with combustible material able to produce heat sources, such as charcoal, and then foodstuffs the user wants to barbecue (such as: sliced meat, fish, and the like) can be placed on the first top mesh 35 and the second top mesh 45 of the first casing 3 and the second casing 4 respectively. Moreover, because the first casing 3 and the second casing 4 are provided with the first top opening 34 and the second top opening 44 respectively, thus, the quantity of heat produced by the charcoal is dispersed through the first top opening 34 and the second top opening 44, thereby achieving effectiveness to barbecue the sliced meat, fish, and the like.

Furthermore, because the holding grill 5 of the present invention is dismountably mounted between the first side opening 32 and the second side opening 42, thus, the user is able to first grasp the handle 52 and take out the holding grill 5 from the barbecue grill 1, after which foodstuffs the user wants to toast (such as: slices of bread, bread rolls, and the like) can be placed on the holding grill 5. And after placing the foodstuffs on the holding grill 5, then the holding grill 5 can be returned between the first side opening 32 and the second side opening 42, and the fastening member 53 is used to securely fasten the holding grill 5 to the supports 54, thereby preventing the holding grill 5 from falling out. Moreover, because the first casing 3 and the second casing 4 are provided with the first side opening 32 and the second side opening 42 respectively, then the quantity of heat produced by the charcoal will at the same time disperse from the first side opening 32 and the second side opening 42. Hence, bread can be toasted at the same time as barbecuing sliced meat, and because both sides of the bread are toasted, thus, there is no need to repeatedly turn the bread over to complete toasting of the bread, thereby realizing the practical advancement of simultaneous toasting of both sides of foodstuffs.

Moreover, because the present invention fully utilizes the quantity of heat from the charcoal, thus, the quantity of heat dispersing from the first side opening 32 and the second side opening 42 is used to barbecue the foodstuffs on the holding grill 5 like bread rolls, slices of bread, and the like, and does not waste the energy sources, as well as providing effectiveness to save energy and reduce carbon emissions.

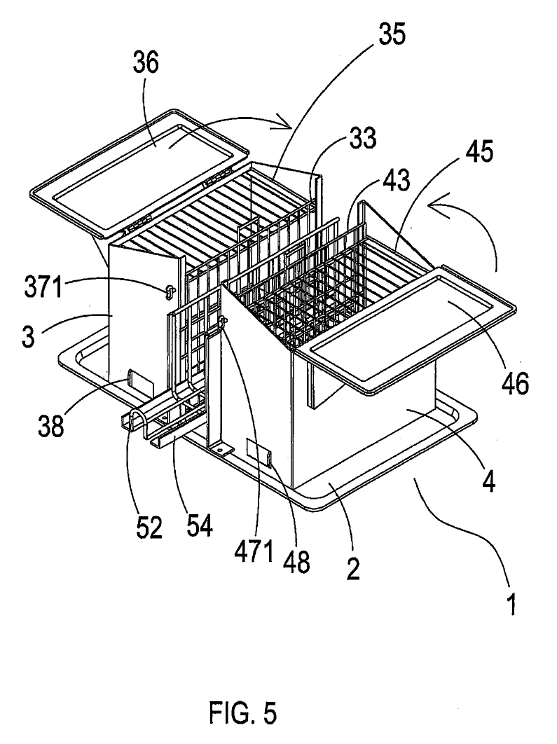

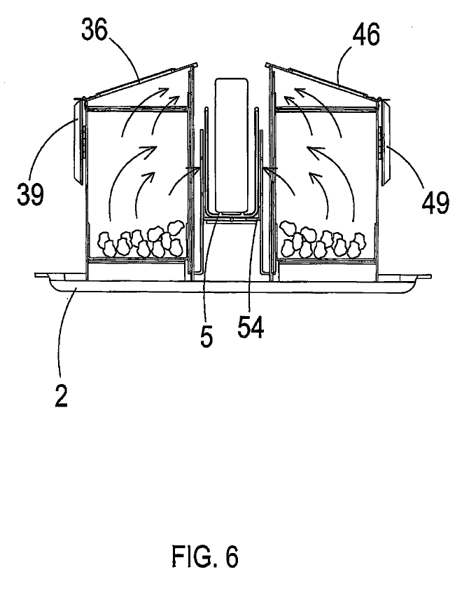

Referring together to FIG. 2, FIG. 5 and FIG. 6, which show the exploded elevational view and implementation schematic views 3, 4 respectively of the preferred embodiment of the present invention, and it can be clearly seen from the drawings that when only wanting to barbecue both sides of foodstuffs, then the user need only apply a slight force to the first cover plate 36 and the second cover plate 46 to cause them to cover the first top opening 34 of the first casing 3 and the second top opening 44 of the second casing 4 respectively. And it can be seen from FIG. 6, because the first top opening 34 and the second top opening 44 are covered, then the quantity of heat produced by charcoal is only able to disperse from the first side opening 32 of the first casing 3 and the second side opening 42 of the second casing 4, thus, barbecuing can be effectively carried out on foodstuffs on the holding grill 5, and dispersal of the quantity of heat at this time will be relatively larger, thereby enabling accelerated barbecuing of foodstuffs on the holding grill 5.

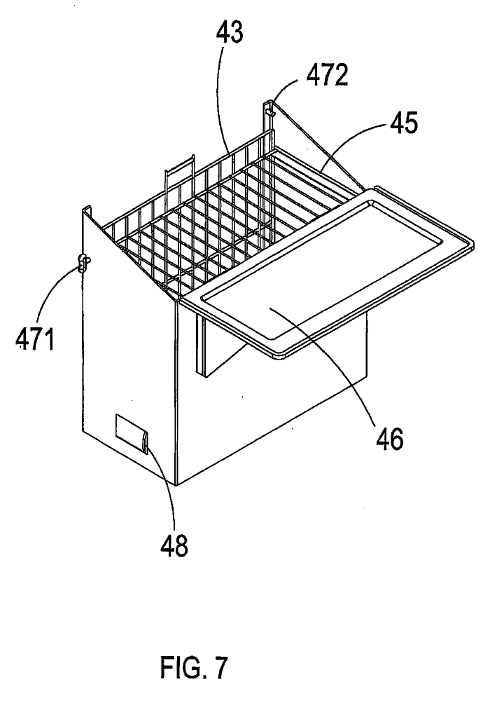

Referring together to FIG. 2 and FIG. 7, which show the exploded elevational view and an implementation schematic view 5 respectively of the preferred embodiment of the present invention, and it can be clearly seen from the drawings that because of the first support stands 39 formed on the first casing 3 that enable supporting the first cover plate 36, and the second support stands 49 formed on the second casing 4 that enable supporting the second cover plate 46, thus, when the first cover plate 36 and the second cover plate 46 are opened, then the barbecued foodstuffs can be placed on the opened first cover plate 36 and second cover plate 46, thereby enabling the opened first cover plate 36 and second cover plate 46 to serve as food trays.

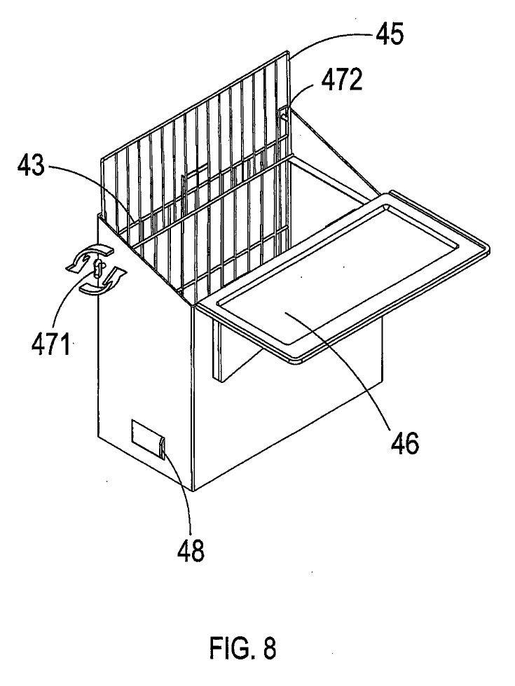

Referring together to FIG. 2 and FIG. 8, which show the exploded elevational view and an implementation schematic view 6 respectively of the preferred embodiment of the present invention, and it can be clearly seen from the drawings that because the first magnetic members 371 are further magnetically connected to the first pin connected portions 37, and the second magnetic members 471 are further magnetically connected to the second pin connected portions 47, thus, when the first top mesh 35 and the second top mesh 45 need to be lifted open, then magnetic attraction of the first magnetic members 371 and the second magnetic members 471 to the first pin connected portions 37 and the second pin connected portions 47 respectively enables the user to rotate the first magnetic members 371 and the second magnetic members 471 using a tool to lift open the first top mesh 35 and the second top mesh 45, thereby enabling replacement of combustible materials such as charcoal, and the like.

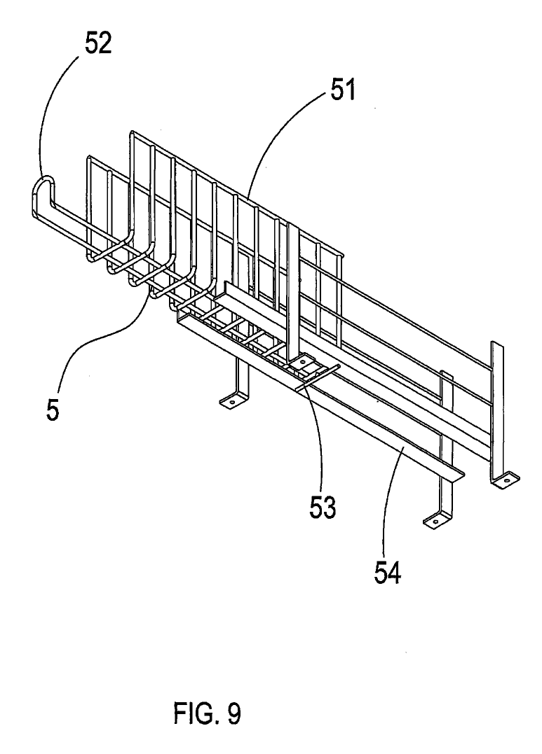

Referring together to FIG. 2 and FIG. 9, which show the exploded elevational view and an implementation schematic view 7 respectively of the preferred embodiment of the present invention, and it can be clearly seen from the drawings that the holding grill 5 is disposed on the supports 54, and the fastening member 53 able to be securely fastened to the supports 54 is located on one end of the holding grill 5. Moreover, the supports 54 are configured in the form of tracks, and the holding grill 5 can slide on the supports 54. In addition, the fastening member 53 located on the holding grill 5 is used to prevent the holding grill 5 sliding off the supports 54.

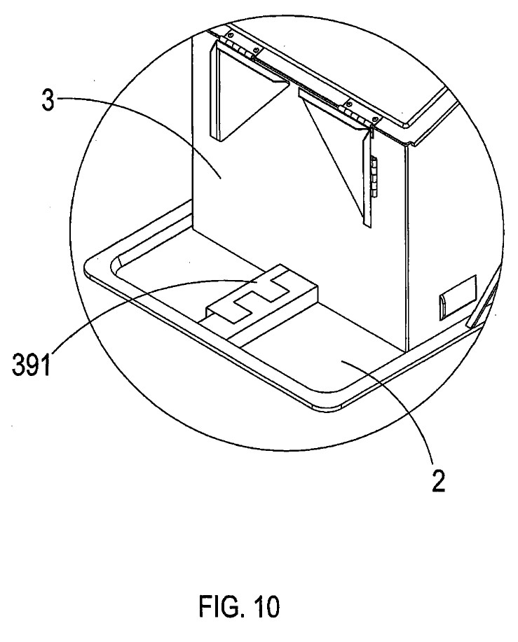

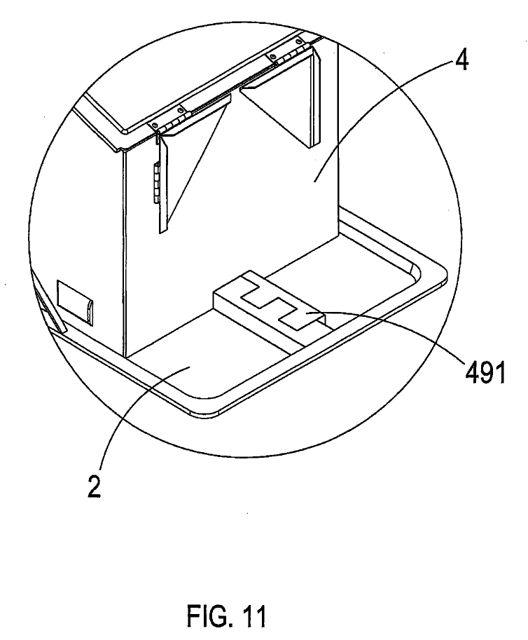

Referring together to FIG. 2, FIG. 10 and FIG. 11, which show the exploded elevational view and implementation schematic views 1, 2 respectively of another preferred embodiment of the present invention, and it can be clearly seen from the drawings that fasteners 391, 491 are formed on the outer walls of the first casing 3 and the second casing 4 respectively, wherein the fasteners 391, 491 enable fixing to the bottom tray 2. Accordingly, when barbecuing, the first casing 3 and the second casing 4 can be adjusted to the required distance according to actual circumstances in order to obtain a relatively higher temperature or relatively lower temperature. After adjustment, the fasteners 391, 491 are then used to fix the first casing 3 and the second casing 4 to the bottom tray 2.

Hence, referring to all the drawings, compared to the prior art, the following advantages exist when using the present invention:

When wanting to barbecue foodstuffs, because the holding grill 5 of the present invention is disposed between the first side opening 32 and the second side opening 42, thus, the user is able to simultaneously place sliced meat on the first top mesh 35 of the first casing 3 and the second top mesh 45 of the second casing 4, as well as being able to place slices of bread on the holding grill 5. Hence, when charcoal is burning and producing a quantity of heat, because the quantity of heat produced by the charcoal disperses from the first side opening 32 and the first top opening 34 of the first casing 3, as well as the second side opening 42 and the second top opening 44 of the second casing 4, thus, the slices of meat as well as the slices of bread can be simultaneously barbecued. Furthermore, effectiveness to realize toasting of both sides of slices of bread placed on the holding grill 5 is achieved. Accordingly, the present invention achieves the practical advancement of simultaneous barbecuing of both sides of foodstuffs.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A barbecue grill structure, comprising:
a first casing, the interior of the first casing is defined with a first holding space, a first side opening is defined in one side of the first holding space, a top end is defined with a first top opening that intercommunicates with the first side opening, and a first top mesh is mounted on the position of the first top opening;
a second casing, the interior of the second casing is defined with a second holding space, a second side opening is defined in one side of the second holding space corresponding to the first side opening, a top end is defined with a second top opening that intercommunicates with the second side opening, and a second top mesh is mounted on the position of the second top opening;
a holding grill, the holding grill is dismountably mounted between the first side opening and the second side opening, and two side meshes respectively upwardly extend from two sides of the holding grill.

2. The barbecue grill structure according to claim 1, wherein the first top opening and the second top opening are covered with a first cover plate and a second cover plate respectively.

3. The barbecue grill structure according to claim 2, wherein first pin connected portions extend from the first top mesh, and the first pin connected portions enable the first top mesh to be movably connected to the first casing; second pin connected portions extend from the second top mesh, and the second pin connected portions enable the second top mesh to be movably connected to the second casing.

4. The barbecue grill structure according to claim 1, wherein the barbecue grill is placed on a bottom tray.

5. The barbecue grill structure according to claim 1, wherein a handle extends from one end of the holding grill.

6. The barbecue grill structure according to claim 1, wherein a first side mesh is located at the first side opening.

7. The barbecue grill structure according to claim 1, wherein a second side mesh is located at the second side opening.

8. The barbecue grill structure according to claim 1, wherein air regulators respectively penetrate the first casing and the second casing.

9. The barbecue grill structure according to claim 3, wherein the first pin connected portions are further magnetically connected to first magnetic members, and the second pin connected portions are further magnetically connected to second magnetic members.

10. The barbecue grill structure according to claim 1, wherein the holding grill is disposed on supports.

11. The barbecue grill structure according to claim 10, wherein a fastening member which enables fastening to the supports is located at one end of the holding grill.

12. The barbecue grill structure according to claim 2, wherein first support stands which enable supporting the first cover plate are formed on the first casing, and second support stands which enable supporting the second cover plate are formed on the second casing.

13. The barbecue grill structure according to claim 1, wherein fasteners are respectively formed on the outer walls of the first casing and the second casing.

14. The barbecue grill structure according to claim 1, wherein magnets able to magnetically attract the first top mesh and the second top mesh are respectively formed on the inner walls of the first casing and the second casing.
